(19) United States
(12) Patent Application Publication
(10) Pub. No.: US 2006/0198122 A1
(43) Pub. Date: Sep. 7, 2006

(54) Illuminated headwear

(75) Inventors: Robert L. Senter, Castle Rock, CO (US); Robert E. Matuszewski, Castle Rock, CO (US)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(73) Assignee: R2 Innovation LLC, Castle Rock, CO (US)

(21) Appl. No.: 11/073,397

(22) Filed: Mar. 4, 2005

(51) Int. Cl. F21V 21/084

(52) U.S. Cl. 362/105; 362/106

(57) ABSTRACT

An illuminated cap, visor, beanie, headband, helmet or similar headwear having an illumination system that is switch activated. The illumination system has one or more light sources that interact and/or interface with a light transmitting medium, such as a polymer lens, to generate illumination. The light source may be activated by a switch, such as a momentary pressure switch, a voice activated circuit, or the like. The switch may also be employed to switch the operation of the light source among various modes, such as a continuous light mode, a flashing mode, or an off mode.

### INVENTIVE FIELD

The inventive field relates generally to illuminated headwear. More particularly, the inventive field relates to headwear which includes one or more light sources that interact and/or interface with one or more light transmitting mediums to illuminate one or more areas proximate to the headwear.

### BACKGROUND

It is desirable for individuals participating in activities conducted under various conditions to be detectable. For example, in low light or dark conditions, persons outdoors are often less detectable by known hazards such as vehicular traffic or the like. Construction road crews, police officers, firefighters, joggers, motorcyclists, bicyclists and military personnel can be exposed to injury or death if not seen or detected. This, of course, is particularly true in low light conditions or at night, but can be true even in inclement weather conditions, such as storms and the like. Similarly, ushers for indoor and outdoor venues often need to be visibly detectable by others under bright or dark conditions. Further, military personnel engaged in combat or the like may be exposed to injury or death from friendly fire if their position is not discernible. Thus, a need exists for systems, apparatus and/or methods for facilitating detection of individuals participating in activities under bright light, low light, inclement weather or other conditions.

### SUMMARY

Generally, the various embodiments of the present invention provide illuminated headwear having an enclosure for surrounding some or all of one's head. Coupled with the enclosure is at least one light source. At least one light transmitting material is positioned proximate to, and interacts with, the light source to increase the visibility of the illumination created by the light source. In addition, a battery source for energizing the light source, and a switch for selectively activating and deactivating the light source, are provided.

Other embodiments and advantages of the invention will be realized by those skilled in the art upon reading the detailed description, provided below.

### BRIEF DESCRIPTION OF DRAWINGS

FIG. 1 is an isometric view of a headwear according to an embodiment of the invention wherein the headwear is a cap having an illumination system mounted therein.

FIG. 2 is an inside plan view of the headwear depicted in FIG. 1 showing one or more compartments and the illumination system situated respectively therein.

FIG. 3 is a side view of the headwear depicted in FIG. 1 showing the illumination system and the location of a contact switch.

FIG. 4 is a front view of a second headwear embodiment of the present invention, wherein the headwear is a visor having an illumination system mounted therein.

FIG. 4A is a sectional view of the headwear embodiment taken along the line 4A-4A in FIG. 4.

FIG. 5 is a side view of the headwear embodiment depicted in FIG. 4 showing a contact switch located on the side of the visor.

FIG. 6 is a front view of a third headwear embodiment of the present invention, wherein the headwear is a beanie having an illumination system mounted therein.

FIG. 7A is a side view of an illumination system according to an embodiment of the present invention.

FIG. 7B is a top view of the illumination system of FIG. 7A.

FIG. 7C is a magnified top view of a connector of the illumination system of FIG. 7A.

FIG. 8A is a side view of an illumination system according to a second embodiment of the present invention.

FIG. 8B is a top view of the illumination system depicted in FIG. 8A.

FIG. 9A is a side view of an illumination system according to a third embodiment of the present invention.

FIG. 9B is a top view of the illumination system depicted in FIG. 9A.

FIG. 10 is an enlarged sectional view of the modular configuration of the illumination system of FIG. 9B.

FIG. 11A is a bottom view of an illumination decal according to embodiment of the present invention.

FIG. 11B is a side view of the illumination decal of FIG. 11A.

FIG. 11C is a top view of the illumination decal of FIG. 11A.

FIG. 11D is an isometric view of the illumination decal of FIG. 11A attached to a fourth headwear embodiment of the present invention.

FIG. 12 is an isometric view of an embodiment of an illumination system of the present invention as utilized in the illumination decal embodiment depicted in FIG. 11.

FIG. 13 is a top view of the illumination system depicted in FIG. 12.

FIG. 14 is a side view of the illumination system depicted in FIG. 12.

FIG. 15 is a partial enlarged section view of the illumination system of FIG. 12.

FIG. 16 is an isometric view of a fifth headwear embodiment of the present invention, wherein the headwear is a helmet having an illumination system mounted thereon.

FIG. 17 is a side view of a headwear embodiment of FIG. 16 with an illumination decal affixed thereto according to an embodiment of the present invention.

FIG. 18 is a schematic diagram illustrating circuitry for an illumination system employing a momentary switch according to a first embodiment of the present invention.

FIG. 19 is a schematic diagram illustrating circuitry for an illumination system employing a voice activation circuit according to a second embodiment of the present invention.

### DETAILED DESCRIPTION

Various embodiments of the present invention relate generally to apparatus, systems and/or methods for facilitating detection of persons and/or objects under various lighting and/or other conditions. In particular, one embodiment provides for illuminated headwear which may be suitably utilized to detect a wearer of such headwear. Further, other embodiments of the present invention relate to illuminated decals that may be used in bright light, low light, or no light conditions, in conditions of inclement weather or otherwise, and/or assist others in detecting an individual's presence. In one embodiment, a device is provided which enables an individual to participate in any number of activities while making himself or herself more visible or otherwise detectable by others.

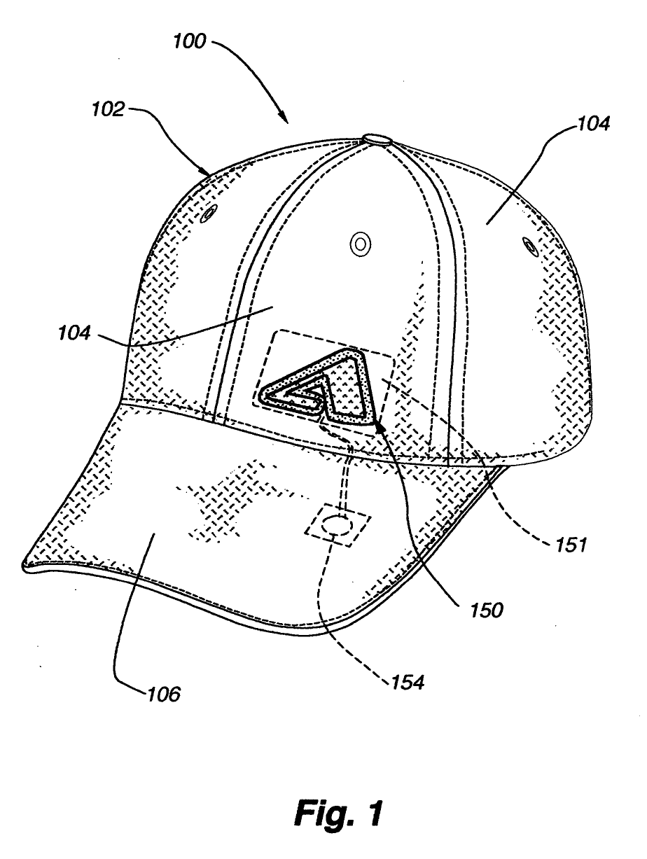

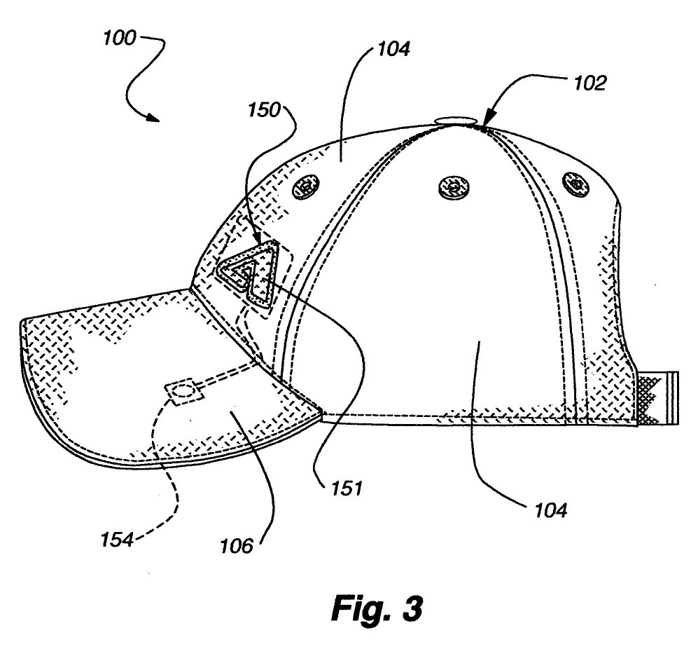

FIGS. 1-3 illustrate a first headwear embodiment of the present invention, wherein the headwear is a cap which incorporates an illumination system. Caps are commonly known attire worn on the heads of men, women and children. Generally, caps provide an upper or dome section that lays atop the head of the cap wearer. The upper/dome section typically has one or more flexible panels made from fabric, leather, plastic, GORETEX or other water resistant/proof materials, combinations thereof or other materials. Such panels are commonly sewn together, molded or produced to ultimately form the upper or semi-spherical dome shape of the headwear. Further, caps commonly, but not necessarily, have a bill or brim 106 which protrudes orthogonally from the base of the upper/dome section and is affixed around substantially half of the circumference of the base of the upper/dome. The bill is typically made from a thin, flexible material such as cardboard, plastic, or the like, and is generally covered by the same material from which the dome section is fashioned. Due to its flexible nature, the bill 106 commonly has a slightly arcuate plane whereby the shape of the bend in the bill depends on the preference of the wearer.

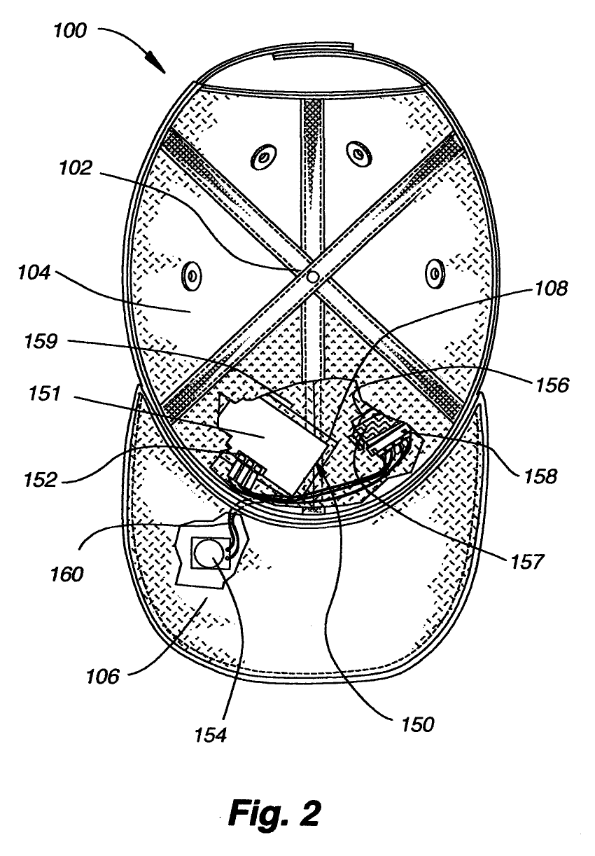

Referring more particularly to the embodiment depicted in FIGS. 1-3, a cap 100 incorporating the illumination system 150 is shown. As shown in FIG. 1, the cap 100 provides a dome section 102 with two adjacent front panels 104 and a bill 106 that orthogonally protrudes from the base of the dome section 102 as an arcuate plane. Referring to FIG. 2, on the inside of the left front panel 104 is a compartment 108 provided for housing a portion of the illumination system 150, which includes a polymer lens 151. The polymer lens 151 may include opaque and/or reflective optical attributes to interact and/or interface with a light source or sources 152 situated therewith. Generally, the polymer lens 151 may be extruded from adhesive thermoplastic opaque pellets and/or pellets with reflective optical attributes. It is to be appreciated that the polymer lens 151 may vary in size, shape and/or color.

In one embodiment, the light source(s) 152 are situated alongside the outer edge of the polymer lens 151. In the embodiment of FIG. 2, the light sources are red, green and blue light emitting diodes (“LEDs”) situated side by side, in no particular order, along the outer edge of the polymer lens 151 such that they are contiguous with the outer center of the lens. The polymer lens 151 interacts and/or interfaces with the illuminated light sources (LEDs) 152 to transmit, refract, reflect, amplify, disperse, radiate or otherwise increase the visibility of light emitted by the different colored LEDs. As such, the illumination system 150 may be configured to illuminate the red, green and blue LEDs at various intermittent frequencies such that the combinations of different amplitudes and wavelengths of light generate a broad array of colors of light across the color spectrum. It is to be appreciated that the light sources can be any one or more and/or combination of a wide variety of light sources such as a visible LED, an infrared light emitting diode, a light bulb, a source of light emitting wavelengths of 940 nm, or any other suitable source of visible and non-visible electromagnetic waves. For example, in one embodiment of the present invention, the illumination system may include light sources 152 emitting “light” at both visible and infra-red wavelengths. Such emissions may occur simultaneously, alternately, periodically or at any other instance or frequency.

In another embodiment, as discussed further below, the illumination system 150 is configured to operate in three modes, namely, but not limited to: (1) “on-continuous”, (2) “on-flashing”, and (3) “off”. In other embodiments, there may be fewer, more, and/or other modes that may be supported. In various embodiments of the present invention, a momentary switch is used to activate, deactivate and select between the different operational modes of the illumination system 150. Further, the illumination system may be activated upon receipt of an “activation signal” such as a radio frequency transmitted inquiry, e.g. a “friend or foe” inquiry by a military or police unit.

The illumination system 150 may be energized by a (non)rechargeable battery, fuel cell, solar energy, generator or other suitable power source(s).

More specifically in reference to FIG. 2, a battery 156 and accompanying electronic circuitry are situated together in a remote modular configuration 158 with the momentary switch 154 located under the bill 106 of the cap 100. In order to supply power to the light source(s) 152, the remote modular switch and battery configuration 158 is connected to the light source(s) 152 by a conductive wire(s) and/or cable(s) 160.

The modularity of the illumination system 150 allows for the switch 154 and remote modular configuration 158 to be placed in remote, typically hidden, locations on or around the cap 100 that is convenient for a wearer of the cap 100 to easily activate/deactivate the illumination system 150. As shown in FIGS. 1-3, the modular switch 154 is located inside the bill 106 proximate the right front panel 104 containing the light source(s) 152 and polymer lens 151. In the embodiment shown, the remote modular configuration 158 is held in place by an elastic strap 157 and positioned under a compartment 159 along with the illumination system 150. It is to be appreciated, that in other embodiments of the present invention, the illumination system 150, switch 154 and remote modular configuration 158 may be otherwise positioned, secured and hidden (if desired) on the headwear 100.

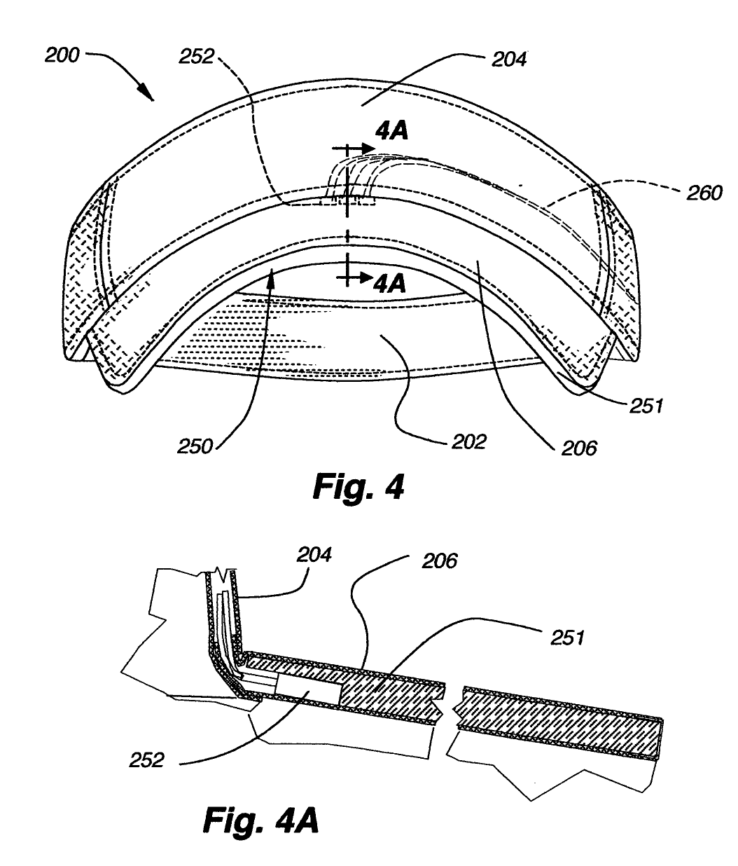

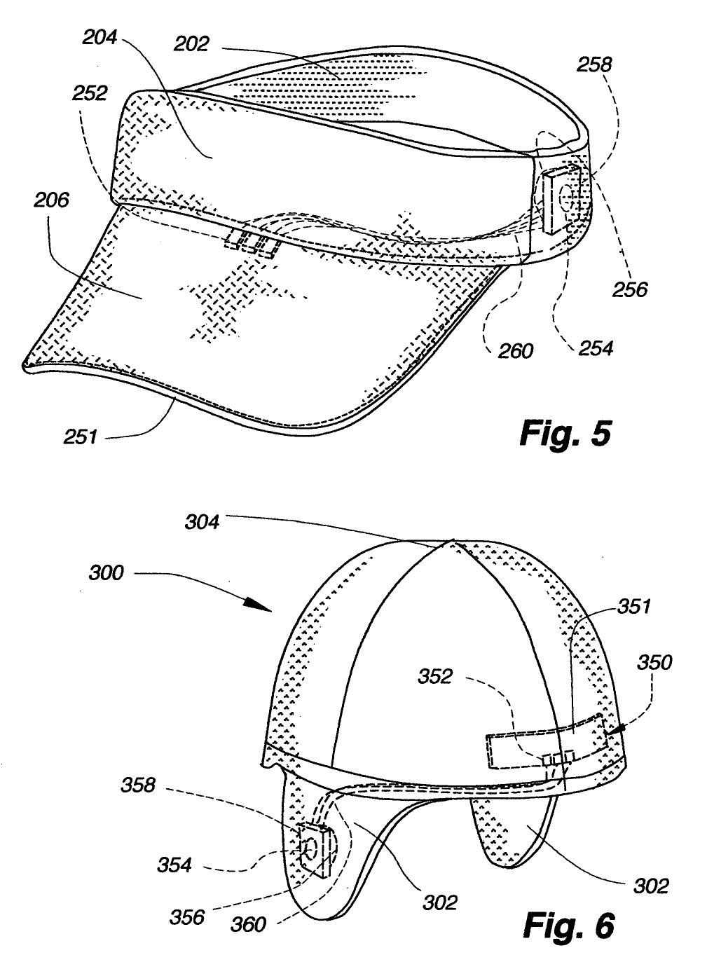

FIGS. 4, 4A and 5 show another embodiment of the present invention wherein the headwear is a visor 200 having an illumination system 250. The visor 200 shown in FIGS. 4, 4A and 5 takes the form of a conventional visor having a front panel 204 extending generally over a wearer's forehead. A head strap 202, typically having elastic-like qualities, extends from one end of the front panel 204 to the other end and secures the visor 200 to the head of a wearer. Similar to the cap 100 (FIG. 1), an arcuate bill 206 extends orthogonally from the base of the front panel 204. The illumination system 250 has a translucent flexible polymer lens 251 that is shaped to cover a portion of and/or the entire top of the bill 206. In one embodiment, only the front edge of the polymer lens 251 is visible, with the top and bottoms of the lens 251 being covered by a material. In other embodiments, the material covering the lens 251 may be opaque or partially opaque. It is to be appreciated that such a bill 206 and lens 251 configuration is not limited to use in visors and may also be utilized in caps or other headwear configurations, where it is desirable to illuminate at least an exposed edge of the headwear.

One or more light sources 252, such as LEDs, are located proximate to the polymer lens 251 so that the light source(s) 252 may interact and/or interface with the polymer lens 251 in a manner as described above with respect to the cap 100 of FIGS. 1-3. Similarly, one or more lens 251 may be used in the various embodiments of the present invention. Such lenses may utilize polymer lenses and/or other types of lenses, as desired.

A modular switch and battery configuration 258 can be located on or inside the head strap 202, typically on the side of the visor 200. It is to be appreciated that in various embodiments of the present invention, the modular switch and battery configuration 258 may be placed at any suitable location on or around the visor 200. The light source(s) 252 is connected to the modular switch and battery configuration 258 via one or more wires 260 that are situated inside and/or on the head strap 202. Moreover, the illumination system 250 may be configured to operate in various modes including, but limited to, those previously discussed hereinabove. In various embodiments of the present invention, a momentary switch 254 is used to activate, deactivate and select between the different operational modes of the illumination system 258. Further, the illumination system 250 may be energized by a battery 256 or other suitable power source.

FIG. 6 depicts another headwear embodiment of the present invention, wherein the headwear is a beanie 300 having an illumination system 350. Typically, a beanie 300 is a stocking cap 304, or other closely fitting headwear, which may include triangularly shaped flaps 302 (or straps) affixed to opposing ends of the stocking cap that hang over the sides of a wearer's head to provide sound, temperature, environmental and/or other protection to the ears of a wearer. That is, the flaps may include audio speakers (and microphones), for example, for use by astronauts, test pilots, NASCAR drivers, firefighters and the like. The illumination system 350 has one or more transparent plastic or fabric cover 351 situated, for example, on the front portion of the beanie 300. One or more light sources 352 are embedded within the beanie 300 proximate to the cover 351 so that light emitted by the source 352 may interact and/or interface with the cover 351. The combination may be used to produce light emissions detectable under bright light, low light, inclement weather, using night vision goggles, in dense smoke or other environmental conditions, in a fashion similar to that described above in relation to the cap 100 and visor 200.

As set forth with respect to the above described embodiments, a modular switch and battery configuration 358 can be suitably located on the beanie, for example on the inside one of the flaps 302. The light source(s) 352 is connected to the modular switch and battery configuration 358 via one or more wires 360 that are typically situated inside the beanie 300. Moreover, the illumination system 350 may be configured to operate in any number of modes including, but not limited to, those discussed previously hereinabove. In various embodiments of the present invention, a momentary switch 354 is used to activate, deactivate and select between the different operational modes of the illumination system 350. Further, the illumination system 350 is energized by a battery 356 or other suitable power source. It is to be appreciated that in various embodiments of the present invention, the modular switch and battery configuration 358 may be placed at any suitable location on or around the beanie 300.

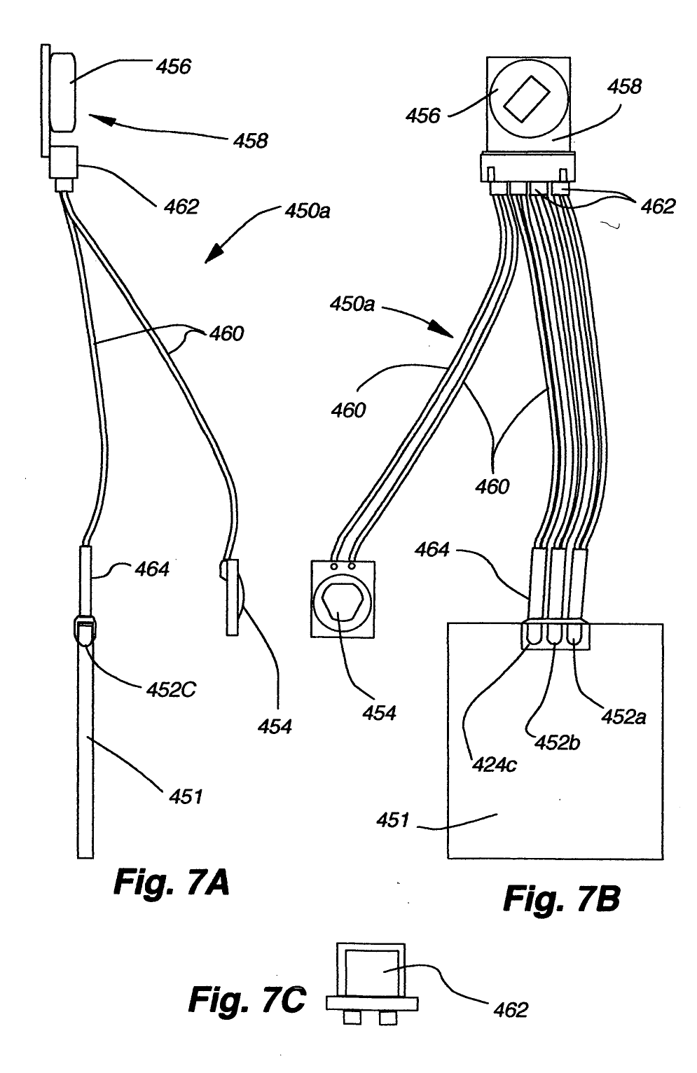

Referring to FIGS. 7A-7C, 8A-8B, 9A and 9B, various implementations of an illumination system 450a-c employable with any of the embodiments of the invention are shown in greater detail. As depicted in FIGS. 7A and 7B, a red LED 452a, a green LED 452b and a blue LED 452c are situated side by side along an edge of a substantially square polymer lens 451 of an illumination system 450a. Each LED 452a-c is connected to a battery configuration 458 via wires 460. A momentary switch 454 may be separately connected via wires 460 to the battery configuration 458. In one particular embodiment, each pair of LED wires 460 terminates at a pin connector 462 (shown in greater detail in FIG. 7C) affixed to the periphery of the modular switch and battery configuration 458. In other embodiments, the wires 460 may be soldered, connected via a multi-pin connector or others connected to the battery configuration 458, the LEDs 452a-c or otherwise.

Further, shrink tubing 464 or other known techniques may be employed to secure the wires 460 to the LEDs 452a-c, momentary switch 454 and/or the polymer lens 451.

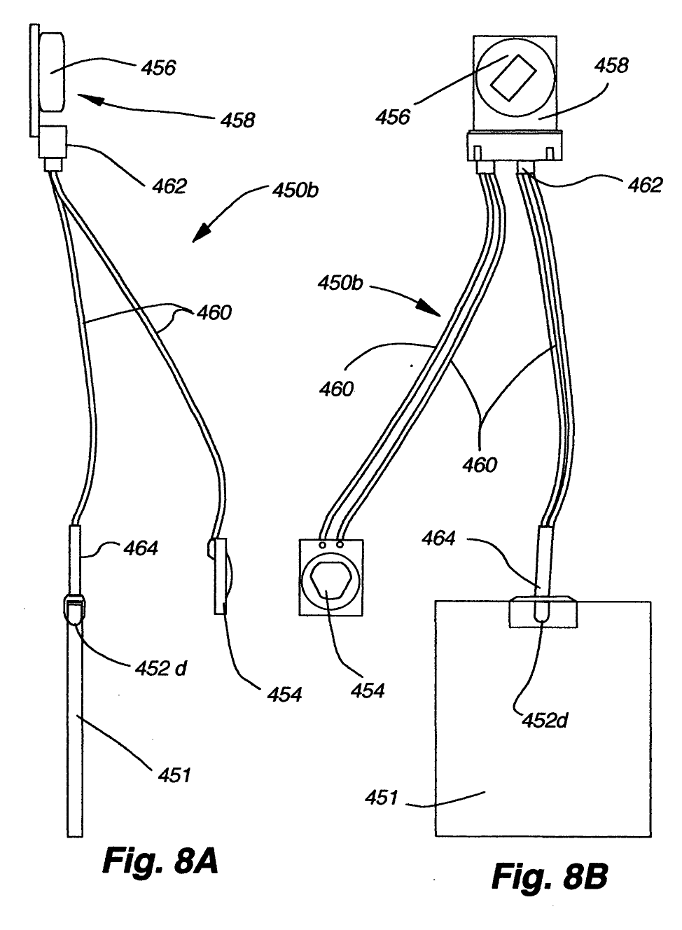

FIGS. 8A and 8B depict an embodiment of an illumination system 450b having a single multiple frequency light source 452, such as an LED which emits red, green and blue light. Wires 460 connect the light source 452 to the battery configuration 458. Such connection may be accomplished using a single 2-pin connector 462 or other known techniques. A momentary switch 454 may also be connected via wire(s) 460 to the battery configuration 458.

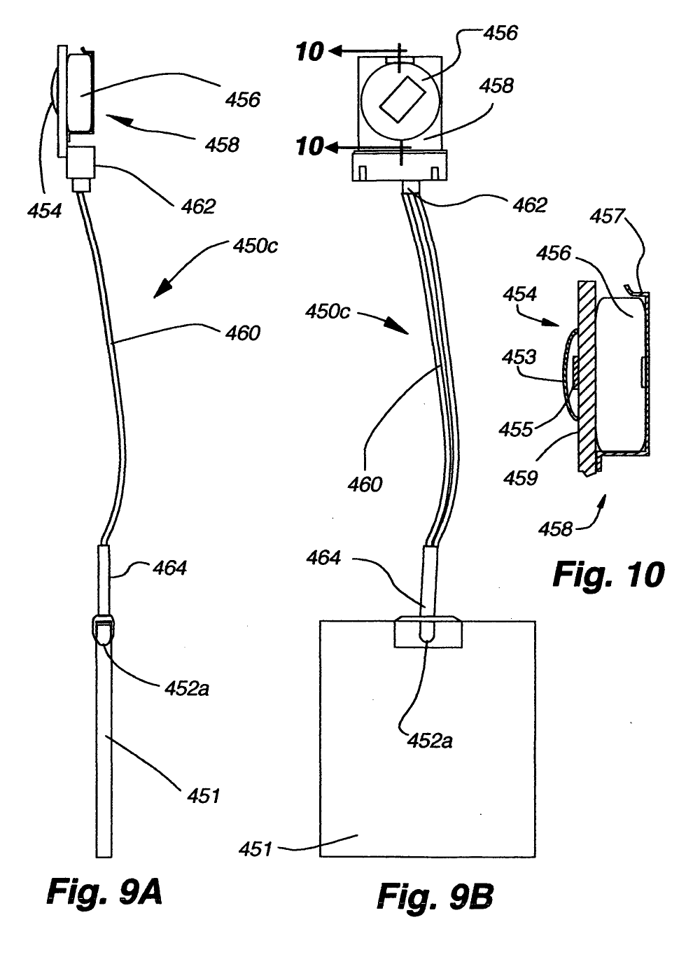

In FIGS. 9A and 9B, an embodiment of an illumination system 450c is shown which utilizes a single light source 452 and a combined modular switch and battery configuration 458. It is to be appreciated, as discussed above, that any number of light sources, wires, lens, battery configurations and the like may be utilized in the various embodiments of the present invention.

The illumination system 450a-c is typically dimensioned so that it will easily reside within a cap, visor, helmet or other headwear while facilitating the emission of electromagnetic energy at a variety of wavelengths, such as visible light, that is detectable in a variety of environmental conditions.

In one embodiment of the invention, the modular configuration 458 is approximately 20 millimeters (mm) wide and 30 mm long. The 2-pin connectors 462 coupled with the modular configuration 458 are approximately 5 mm wide, 6.5 mm long, and 3 mm thick. Further, the polymer lens 451 is approximately 50 mm wide by 60 mm long. The wires coupling the 2-pin connectors 462 and the polymer lens 451 are approximately 180 mm in length. It is to be appreciated that FIGS. 7A-7C, 8A, 8B, 9A and 9B merely illustrate particular uses of the various components in a typical illumination system 450a-c. However, the dimensions of the illumination system, the components used therein, the layout of such components and other features thereof may vary greatly while remaining within the scope of the present invention.

FIG. 10 illustrates another embodiment of the present invention, wherein the modular configuration 458 is provided in a more compact design that includes a base 459, such as a small printed circuit board. A battery 456 is biased against the base 459 by way of a retainer 457, which may be designed so that the battery 456 may be replaced by the user. A momentary switch 454 may be fashioned from a flexible member 453 to be depressed by the user onto a switch contact 455 lying atop the base 459, such that electrical contact is made between the flexible member 453 and the contact 455 only while the user depresses the member 455. Other circuitry, described in greater detail below, may also reside on the base 459, thus providing a stable, defect-resistant modular configuration 458.

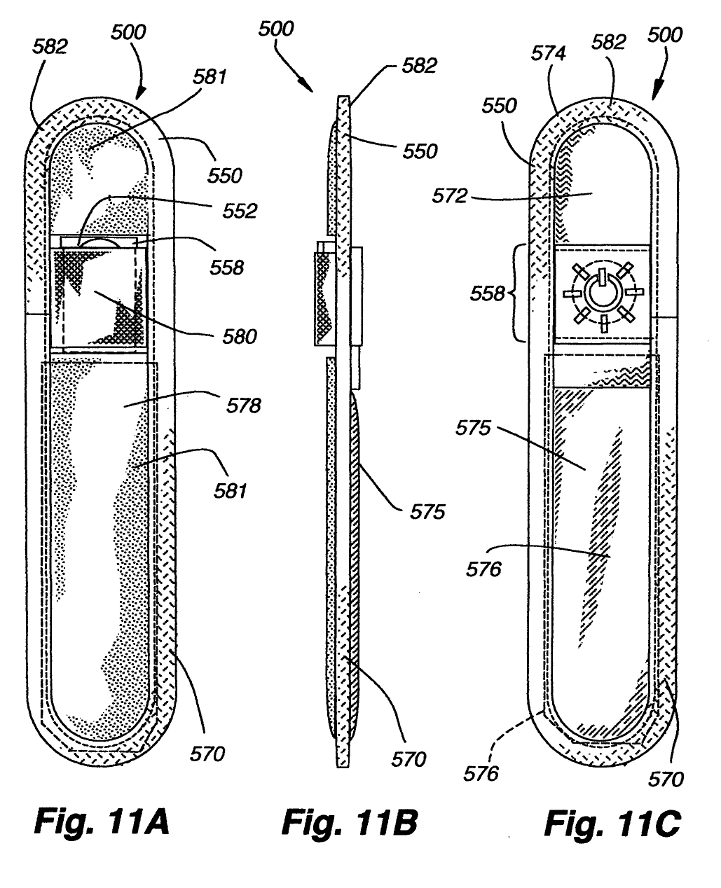

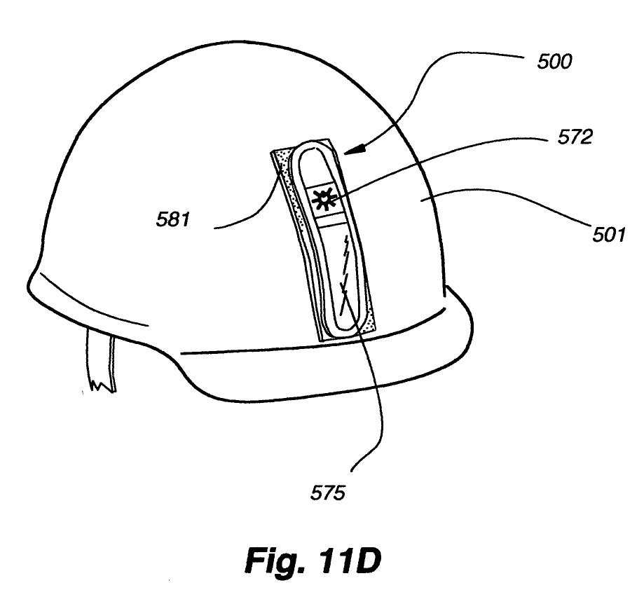

In another embodiment of the invention, FIG. 11 depicts an illuminated decal 500 whereby an illumination system 550, similar to that described above, is housed within a flexible sheath 570. A modular configuration 558 of the illumination system 550 is typically positioned near one end of the sheath 570. Generally, a portion 574 of a top layer 572 of the sheath 570 that covers the illumination system 550 is made from a waterproof fabric, typically nylon. The fabric portion 574 of the top layer 572 of the sheath 570 extends from one end of the sheath and terminates after the opposing end of the modular configuration 558. Adjacent the fabric portion 574 of the sheath 570, a transparent, translucent or fabric cover 575 makes up the remainder of the top layer of the sheath 570, and extends lengthwise, terminating at the opposing end of the sheath 570. The cover 575 allows light from the illumination system 550 within the sheath 570 to be visible externally.

Inside and commonly, but not necessarily, separate from the sheath 570, and coupled with the modular switch and battery configuration 558, are one or more light sources 552, as described above. Coupled with the light source(s) 552 is a transparent thermoplastic polymer, or reflective and/or translucent plastic lens 576 underneath the cover 575 of the sheath 570. The lens 576 interacts or interfaces with the light source(s) 552 in the manner described earlier so that light is detectable from outside the sheath 570. An example of a suitable lens material is disclosed in “Method and Apparatus for Light Transmission”, U.S. Pat. No. 5,879,076 to Cross, an implementation of which is manufactured by PolyBrite International. When the illumination system 550 is activated, the lens 576 distributes a substantially uniform light array across its surface area. In another embodiment, the lens 576 is integrated with the sheath 570, thus allowing the lens to be viewed directly in the absence of a cover 575.

At least a portion of a bottom layer 578 of the sheath 570 may be made from a typical hook and/or loop material 581, such as VELCRO, a registered trademark of the Velcro Company, such that the sheath 570 may be detachably affixed to any surface that provides an adequate surface area of the corresponding hook and/or loop material 581. Other devices and methods of attachment may also be provided include glues, snaps, zippers and others well known in the art.

Underneath the modular switch and battery configuration 558 of the illumination system 550 resides an elastic band 580 extending widthwise across the modular configuration 558 on the bottom layer 578. The elastic band 580 enables the modular switch and battery configuration 558 to be accessed (e.g., to change the battery) by stretching either side of the elastic band 580 along the length of the sheath 570 towards either end of the sheath. Additionally, a fabric trim 582, for example, nylon, may be stitched around the perimeter of the sheath 570 to secure the top layer 572 to the bottom layer 578. As a result of the detachable functionality enabled by the bottom layer 578, the sheath 570 provides a self-contained portable environment for the illumination system 550 to operate within. Thus, the illumination system 550 need not remain fixed to a particular device, article of clothing or the like, and can be readily removed and/or transferred from one position to another on the same or different device, article of clothing or the like providing a complementary material amenable to the bottom layer 578 of the sheath 570.

FIG. 11D illustrate one application of the illumination system 500 denoted in FIGS. 11A-C. As shown, the illumination system 500 may be affixed to headwear, such as a helmet. Similarly, the illumination system 500 may be affixed to vehicles, articles of clothing, gear (e.g., backpacks, skis, firearms, and tents), shoes and practically any item for which it is desired to provide identification thereof via the use of one or more electromagnetic waves such as light waves.

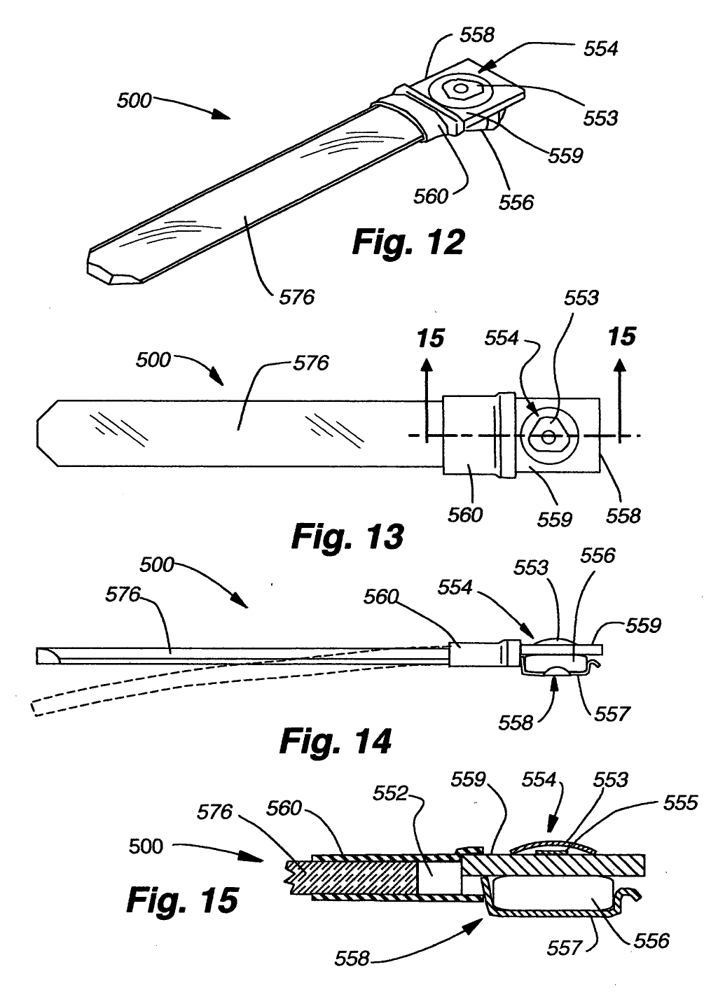

Similar to the modular configuration 458 shown in FIG. 10, the modular configuration 558 displayed in FIGS. 12-15 includes a flexible lens member 576 and a pair of switch contacts 553, 555 atop a base 559, thereby forming a momentary switch 554 for activating the illumination system 500. Also forming the modular configuration 558 is a battery 556, whose position against the base 559, for this embodiment, is maintained by way of a retainer 557. Further, additional circuitry, to be described below, may also reside on the base 559.

Coupled to the modular configuration 558 is one or more light sources 552, actuated by way of the momentary switch 554. In the embodiment of the FIGS. 12-15, the light source 552, such as an LED, is coupled with the lens 576 via a coupler 560. The coupler 560 provides mechanical stability among the base 559, the light source 552, and the lens 576, and may also provide an optical channel through which light emitted from the light source 552 is directed into the lens 576. As shown in FIG. 14, the lens 576 may be somewhat flexible, thus allowing flexing of the lens 576 without placing inordinate stress on the couple 560.

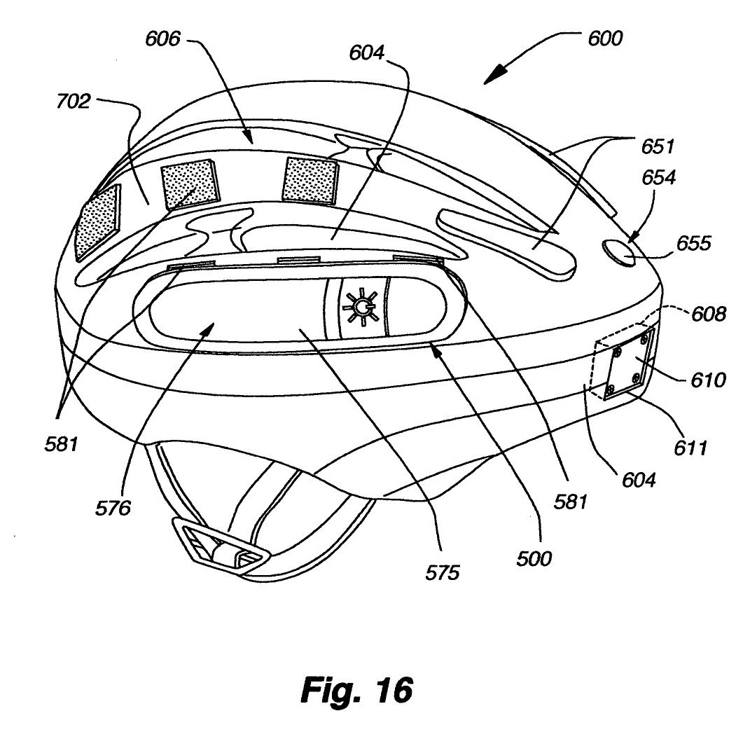

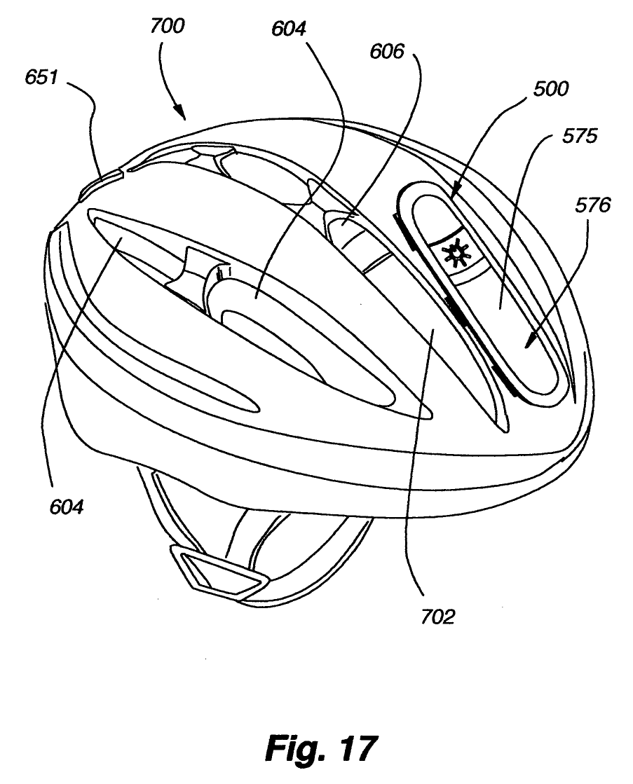

FIGS. 16 and 17 illustrate another headwear embodiment of the present invention, wherein the headwear is a helmet 600 incorporating various implementations of an illumination system. The helmet depicted in FIGS. 16 and 17 may be used for various activities, for example, bicycling, skiing, rock climbing, skydiving, military, police or fire operations, driving or other activities that require protective headgear and identification of a wearer of the same under any of a wide variety of lighting, weather, situational and/or environmental conditions. Generally, an outer shell of the helmet has a semi-spheroidal shape and is constructed from a hard plastic or similar light weight composite material. Alternatively, the headwear may be constructed from materials that are full, partially or not at all resistant and/or impenetrable to bullets, fire, temperature extremes, fluids, impact, noise or any other factor or condition. That is the helmets may be suitably configured for use by military, fire, police, race car drivers, postal carriers, skiers, pilots and others, as needed.

Additionally, the shell of the helmet may contain ancillary materials having various optical attributes that interact and/or interface with the illumination system, such as reflective speckles. A foam, typically polystyrene, liner insulates the underside of the shell to absorb any shock that may result from an intense impact or collision with the helmet. Additionally, a pattern of elongated apertures may extend through both the shell and foam liner to provide ventilation to a wearer of the helmet. Such apertures may be suitably sealed by moving members or otherwise. To secure the helmet to an individual's head, a strap (not shown in FIGS. 16 and 17) may be affixed between the outer shell and liner and extend downwardly from the top of the inside of the helmet. The strap may consist of two yoke arrangements (also not shown) that wrap around either side of an individual's head and are secured by a buckle (not shown) underneath the chin. The helmet may be configured to cover any or all of a person's head as desired. Various combinations of materials, in addition to those described herein, may be utilized in the helmet. For example, a ski helmet may include a hard outer shell covering one's skull, while soft flexible members are used to cover one's ears.

As depicted by FIG. 16, an embodiment of the present invention provides a helmet 600 with an embedded illumination system (not shown) covered by a pair of polymer lenses 651 incorporated in the aft portion of a helmet 600 having a helmet shell 702, liner 604, and apertures 606. The polymer lenses 651 are generally elongated teardrop shaped with light source(s) residing in the wider end of the lens 651. Additionally, the lenses 651 are partially embedded in the helmet shell 702 and slightly protrude above the surface of the shell. The lenses 651 may be constructed from a transparent thermoplastic polymer, or reflective and/or translucent plastic. A contact pressure switch 654 is positioned generally between the polymer lenses 651 on the surface of the shell 702, although many alternative locations for the switch 654 are also possible. A protective button 655 made from rubber, plastic or similar flexible material, covers the contact pressure switch 654 and provides a suitable interface for activating/deactivating the illumination system. A battery and associated circuitry of the illumination system reside in a cavity 608 in the aft portion of the foam liner 604. A plastic housing (not shown) encases the battery and illumination system circuitry, and has a removable panel 610 accessible from the rear of the helmet 600 for changing the battery. Typically, the removable panel 610 is connected to the plastic housing with four screws 611 or an interlocking plastic closure (not shown) located at the corners of the panel 610.

Referring to FIG. 17, another embodiment of the present invention provides a helmet 700 with an embedded illumination system (such as the illumination system of the helmet 600 of FIG. 16, having one or more polymer lenses) in combination with at least one removable illumination decal 500, shown previously in FIG. 11. The illumination decal 500, as described above, consists of an illumination system 576 encased in a flexible sheath 575 providing a VELCRO or similar surface on the bottom side. Complimentary VELCRO pieces may be affixed with an adhesive or epoxy to various locations on the outside of an outer shell 702 of the helmet 700. In one embodiment, three VELCRO squares are affixed proximate one another lengthwise across the shell 702 for receipt of a single illuminating decal 500. As shown in FIG. 17, an illuminating decal 500 is fastened towards the front center of the helmet 700. It is to be appreciated that in various embodiments of the present invention one or more illuminating decals 500 may be placed at any location on or around the shell 702 of the helmet 700.

FIG. 18 is a schematic diagram representing a circuit 800 which may be used in conjunction with any embodiment of an illumination system of the present invention. As shown, a battery 856 is desirably connected to a momentary pressure switch 854 that, in turn, operates a control circuit 884 which includes a mode selector 886. In one embodiment, the mode selector 886 has three modes: (1) “on-continuous”, (2) “on-flashing”, and (3) “off”. In other embodiments, there may be fewer, more and/or other modes that may be supported. When the “on-flashing” mode is selected, the control circuit 884 desirably utilizes a driver 888 which causes the light emitted from a light source(s) 852 (e.g., an LED) or otherwise propagated or transmitted through, by and/or from the illumination system to repetitively transfer between a first state (e.g., “on”) and one or more second states (e.g., “off”) at a predetermined, random and/or variable frequency. Similarly, in the “on-continuous” mode, an electrical current is delivered to and/or by the driver 888 to the light source(s) 852 such that a substantially continuous light is emitted from the light source(s) 852 and/or propagated or transmitted through, by and/or from the illumination system. Last, in the “off” mode, the control circuit 884 is configured such that no light is emitted from the illumination system.

In one embodiment, the switch 854 is a momentary switch so that one needs to hold the switch down for a nominal time before it is operative, thus preventing the light 852 from being inadvertently turned on or off by accidentally touching the switch 854. It is to be appreciated that control circuits, components and/or the like of any given configuration other than that specifically described herein may be used in any of the various embodiments of the present invention. Also, when a simple “on” or “off” mode is desired, it is to be appreciated that the control circuit and driver may be eliminated with a simple series connection between the battery, a switch and the light source. Likewise, additional control circuitry and/or features may be added to the various embodiments of the present invention to facilitate various uses of the illumination system of the present invention, such as facilitating communications via Morris code or the like.

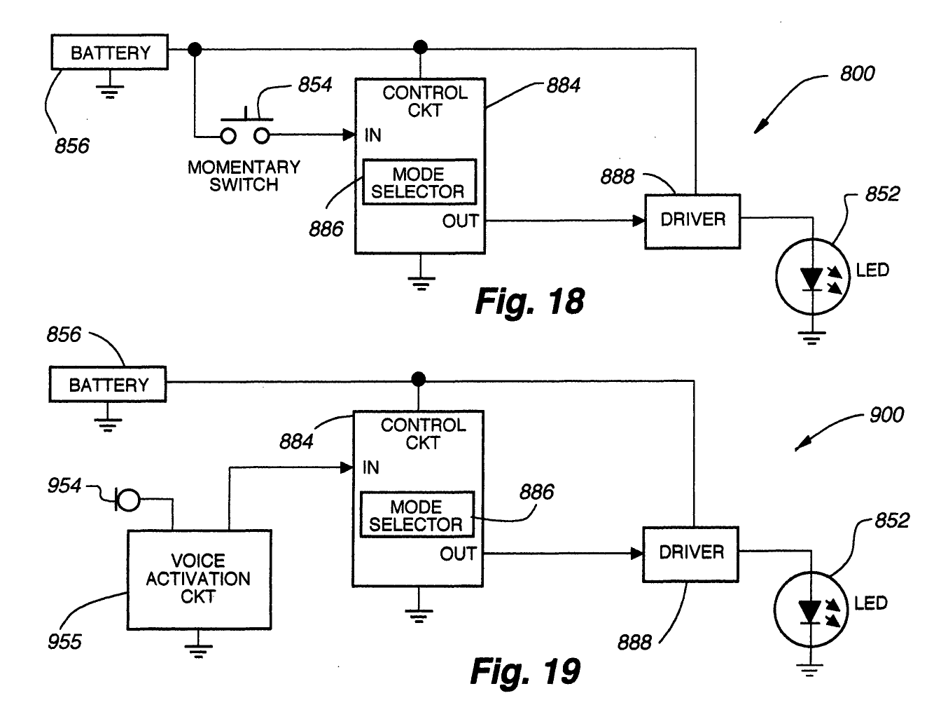

FIG. 19 depicts another embodiment of the present invention providing an illumination system circuit 900 with a voice activated circuit 955. The circuit 900 in FIG. 19 is substantially similar to the circuit 800 in FIG. 18 except that the momentary switch 854 is replaced (and/or augmented) by a voice activation circuit 955, coupled with a microphone 954. As such, the voice activation circuit 955 may be configured to respond to voice commands such as, but not limited to, “on”, “flash”, “off”, “mayday” (for example, when Morris code is utilized) or the like.

While the invention has been described with respect to various embodiments, it will be understood by those skilled in the art that various changes in detail may be made therein without departing from the scope and teaching of the invention, as set forth in at least the following claims.

1. Illuminated headwear, comprising:
an enclosure for surrounding at least a portion of a person's head;
at least one light source coupled with the enclosure;
at least one light transmitting material positioned proximate to the at least one light source;
wherein the at least one light transmitting material interacts with the at least one light source to increase the visibility of the illumination created by the at least one light source;
a battery source for energizing the at least one light source; and
a switch for selectively activating and deactivating the at least one light source.

2. The illuminated headwear of claim 1, wherein the at least one light source is contiguous with the at least one light transmitting material.

3. The illuminated headwear of claim 2, wherein the at least one light transmitting material is a translucent polymer lens.

4. The illuminated headwear of claim 2, wherein the at least one light transmitting material is a thermoplastic polymer lens.

5. The illuminated headwear of claim 2, wherein the at least one light transmitting material is a reflective translucent plastic.

6. The illuminated headwear of claim 1, wherein the at least one light source is embedded in the at least one light transmitting material.

7. The illuminated headwear of claim 6, wherein the at least one light transmitting material is a translucent polymer lens.

8. The illuminated headwear of claim 6, wherein the at least one light transmitting material is a thermoplastic polymer lens.

9. The illuminated headwear of claim 6, wherein the at least one light transmitting material is a reflective translucent plastic.

10. The illuminated headwear of claim 1, further comprising a control circuit having a mode selector; wherein the mode selector facilitates control of the frequencies of light pulses emitted by the at least one light source.

11. The illumination headwear of claim 1, wherein the at least one light source is a light emitting diode.

12. The illumination headwear of claim 1, wherein the at least one light source is an infrared emitting diode.

13. The illumination headwear of claim 1, wherein the headwear is a cap.

14. The illumination headwear of claim 1, wherein the headwear is a visor.

15. The illumination headwear of claim 1, wherein the headwear is a beanie.

16. The illumination headwear of claim 1, wherein the headwear is a helmet.

17. An illumination decal comprising:
at least one light source;
a battery source for energizing the at least one light source;
a switch for selectively activating and deactivating the at least one light source;
a sheath that encases the at least~one light source, the battery and the switch;
wherein the sheath comprises a top layer and a bottom layer, the top layer comprising a flexible transparent lens adjacent the at least one light source, and the bottom layer comprising a surface area of a first material;
wherein the flexible transparent lens interacts with the at least one light source to increase the visibility of the illumination created by the at least one light source;
wherein the surface area of the first material is configured to detachably affix to a surface area of a second material; and
wherein the illumination decal is portable among articles comprising a surface area of the second material.

18. The illumination decal of claim 16, wherein the first and second materials are corresponding surfaces of a hook and loop configuration, such that the first material may be detachably affixed to the second material.

19. The illumination decal of claim 16, wherein the illumination decal is adapted to be detachably affixed to a helmet.

20. The illumination decal of claim 16 further comprising a control circuit having a mode selector; wherein the mode selector facilitates control of the frequencies of light pulses emitted by the at least one light source.

21. The illumination decal of claim 16, wherein the at least one light source is a light emitting diode.

22. The illumination decal of claim 16, wherein the at least one light source is a infrared emitting diode.

23. An illumination decal comprising:
at least one light source;
a battery source for energizing the at least one light source;
a switch for selectively activating and deactivating the at least one light source;
a flexible transparent lens adjacent the at least one light source;
a sheath that encases the at least one light source, the battery, the switch, and the flexible transparent lens;
wherein the sheath comprises a top layer and a bottom layer, the top layer comprising a material allowing the transmission of light therethrough, and the bottom layer comprising a surface area of a first material;
wherein the flexible transparent lens interacts with the at least one light source to increase the visibility of the illumination created by the at least one light source;
wherein the surface area of the first material is configured to detachably affix to a surface area of a second material; and
wherein the illumination decal is portable among articles comprising a surface area of the second material.

24. The illumination decal of claim 23, wherein the first and second materials are corresponding surfaces of a hook and loop configuration, such that the first material may be detachably affixed to the second material.

25. The illumination decal of claim 23, wherein the illumination decal is adapted to be detachably affixed to a helmet.

26. The illumination decal of claim 23 further comprising a control circuit having a mode selector; wherein the mode selector facilitates control of the frequencies of light pulses emitted by the at least one light source.

27. The illumination decal of claim 23, wherein the at least one light source is a light emitting diode.

28. The illumination decal of claim 23, wherein the at least one light source is an infrared emitting diode.
